(19) United States
(12) Patent Application Publication
(10) Pub. No.: US 2007/0047771 A1
(43) Pub. Date: Mar. 1, 2007

(54) Authentication apparatus

(75) Inventors: Keisuke Watanabe, Mizuho-shi (JP); Tatsushi Ohyama, Ogaki-shi (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/509,653

(22) Filed: Aug. 25, 2006

(30) Foreign Application Priority Data
Aug. 25, 2005 (JP) 2005-244885

(51) Int. Cl. G06K 9/00

(52) U.S. Cl. 382/115

(57) ABSTRACT

An authentication apparatus includes an input unit which inputs information on a user's fingerprint, an enrolled-image storage which stores a plurality of enrolled images, namely a plurality of fingerprint images, to be verified against a fingerprint image generated by the input unit, and an authentication unit which authenticates the user's fingerprint in a manner such that verification of the fingerprint image against the plurality of enrolled images stored in the enrolled-image storage is performed sequentially in two stages. In the two stages in the verification performed in the authentication unit, enrolled images to be used in the subsequent stage are selected, in the earlier stage thereof, by verifying the fingerprint image against the plurality of enrolled images, and then the user's fingerprint is identified by verifying the fingerprint image against the selected enrolled images in the subsequent stage.

### BACKGROUND OF THE INVENTION

1. Field of the Invention

The present invention relates to the authentication technology carrying out the user authentication using biological information.

2. Description of the Related Art

In the biometric authentication where the biological information is an object to be identified, the user authentication is carried out by verifying the biological information acquired from the user against the biological information enrolled beforehand (hereinafter referred to as “enrolled biological information”).

Here, in order to make the authentication further accurate, a method is conceivable where the verification of the biological information is performed a plurality of times in one authentication processing. If this authentication of performing the verification a plurality of times is a so-called one-to-N identification in which the authentication is performed by detecting the biological information of the user himself/herself from among a plurality of pieces of enrolled biological information, the verification of the user's biological information against all of the enrolled biological information needs to be done a plurality of times, respectively. In such a case, if the number of pieces of enrolled biological information is small, the verification can be done one by one and the user authentication can be achieved by selecting from them the enrolled biological information which is most closely similar to the user's biological information. However, if the number of pieces of enrolled biological information is large, the verification processing time will be unwieldy long to perform the verification against all of the enrolled biological information. This may not be easily utilized in the actual setting.

In Reference (1) in the following Related Art List, disclosed is a technique where the verification is performed using a correspondence between a plurality of feature points and the positions of their feature points of a fingerprint and then all of fingerprints closely similar to the user's fingerprint are extracted from a plurality of enrolled fingerprints, as those used in the subsequent verification. In this manner, the high-speed operation of user authentication is attempted in Reference (1).

2. Related Art List

(1) Japanese Patent Application Laid-Open No. 2002-197460.

When the biological information to be verified is to be all extracted and if there are a great number of pieces of biological information closely similar to the user's biological information, all of those pieces of biological information will be extracted. In this case, the user's biological information must be verified against all of those extracted pieces of biological information, so that the high-speed user authentication cannot be attempted practically.

### SUMMARY OF THE INVENTION

The present invention has been made in view of the foregoing circumstances and problems, and a general purpose thereof is to speed up the user authentication using biological information.

One embodiment of the present invention relates to an authentication apparatus. This authentication apparatus comprises: an input unit which inputs biological information on an object to be authenticated; a storage which stores a plurality of pieces of reference information to be referred to the biological information inputted in the input unit; and an authentication unit which authenticates the biological information in a manner such that verification of the biological information against the plurality of pieces of reference information stored in the storage is performed sequentially in two stages, wherein, in the two stages in the verification in the authentication unit, reference information to be used in the subsequent stage is selected, in the earlier stage thereof, by verifying the biological information against the plurality of pieces of reference information, and wherein the biological information is verified against the selected reference information in the subsequent stage so as to identify the biological information.

According to this embodiment, the reference information to be referred to in the subsequent stage is selected by the verification in the earlier stage. That is, the number of pieces of reference information referred to in the subsequent stage is reduced. Accordingly, the authentication processing can be performed at higher speed by as much as a decrease in the amount of reference information used in verification.

Here, an intermediate result obtained at the verification in the earlier stage or a verification result in the earlier stage may be used in the verification in the subsequent stage. According to this embodiment, not only the reference information but also the information used in the earlier stage is used in the verification in the subsequent stage, so that a further accurate authentication result is obtained. The “intermediate result” may be the quality of reference information or angles of rotation, for example. The “verification result” may be the degree of similarity, for example.

The authentication unit uses different processings for verification in the two stages, respectively, and may use, in the earlier stage, a processing whose period of time required for verification is shorter than that required for the subsequent stage. The authentication unit uses different processings for verification in the two stages, respectively, and may use, in the earlier stage, a processing such that the identification rejection is less likely to occur than in the subsequent stage. Here, the “identification rejection” means that even if the individual in question is actually a user himself/herself but the verification results shows that the individual is not the same person as the user.

Each of the plurality of pieces of reference information stored in the storage may contain a plurality of patterns, and the authentication unit may verify the biological information against each of the plurality of patterns in each of the two stages, and when the biological information corresponds to at least one of the plurality of patterns, the biological information may be identified.

Another embodiment of the present invention relates also to an authentication apparatus. This authentication apparatus comprises: an input unit which inputs biological information on an object to be authenticated; a storage which stores a plurality of pieces of reference information to be referred to the biological information inputted in the input unit; and an authentication unit which authenticates the biological information in a manner such that verification of the biological information against the plurality of pieces of reference information stored in the storage is performed sequentially in a plurality of stages, wherein, in one of the plurality of stages in the verification in the authentication unit, reference information to be used in a subsequent stage is selected from reference information selected in an early stage of verification by verifying the biological information against the reference information selected in the early stage of verification.

Here, “reference information selected in an early stage of verification” may be all of the reference information stored in the storage in the first stage of the plurality of stages. Also, if the “subsequent stage” is the last stage, the selection of reference information may not carried out in this last stage and the biological information may be identified by verifying the biological information against the reference information selected in the previous stage.

According to this embodiment, the reference information to be referred to in a subsequent stage is selected by the verification in each stage. That is, the number of pieces of reference information is reduced sequentially every time a verification is performed in each stage. Accordingly, the authentication processing can be performed at higher speed by as much as a decrease in the amount of reference information used in the verification.

Here, in one of the plurality of stages, an intermediate result obtained at the verification in the previous stage or a verification result in the previous stage may be used in the verification in the next stage. According to this embodiment, not only the reference image but also the information used in the previous stage is used in the verification in the next stage, so that a further accurate authentication result is obtained.

The authentication unit uses different processings for verification in the plurality of stages, respectively, and may use, in one of the plurality of stages, a processing whose period of time required for verification is shorter than that required for the subsequent stage.

According to this embodiment, as a stage in the plurality of stages is nearer the last stage thereof, the period of time required for verification will be longer. That is, the longer the period of time required for verification, the number of pieces of reference information used in the verification will be smaller, so that the further longer length of processing time can be reduced.

The authentication unit uses different processings for verification in the plurality of stages, respectively, and may use, in one of the plurality of stages, a processing such that the identification rejection is less likely to occur than in a subsequent stage.

According to this embodiment, as a stage in the plurality of stages is nearer the first stage thereof, the higher the accuracy of verification will be, so that the larger number of pieces of reference information can be reduced in the early stages. Thereby, the processing time of verification in later stages can be reduced.

Each of the plurality of pieces of reference information stored in the storage contains a plurality of patterns, and the authentication unit may verify the biological information against each of the plurality of patterns in each of the plurality of stages, and when the biological information corresponds to at least one of the plurality of patterns, the biological information may be identified. Here, “corresponds to” may mean that it is closely similar to at a level greater than or equal to a predetermined degree of similarity.

According to this embodiment, if the inputted biological information corresponds to any of a plurality of patterns contained in the reference information, then it will be authenticated. As a result, the identification rejection rate can be reduced in comparison with a case when the biological information is verified against a single piece of reference information.

Still another embodiment of the present invention relates to a method for authenticating biological information in a manner such that verification of the biological information to be authenticated against a plurality of pieces of reference information to be referred to the biological information is performed sequentially in a plurality of stages. This method is such that in one of the plurality of stages in the verification, reference information to be used in a subsequent stage is selected from reference information selected in an early stage of verification by verifying the biological information against the reference information selected in the early stage of verification.

According to this embodiment, at the verification in each of the plurality of stages, reference information to be referred to in the next stage is selected. Thus, the number of pieces of reference information is reduced every time a verification is performed in each stage. Thereby, the verification and authentication can be performed at higher speed by as much as a decrease in the amount of reference information used in verification.

It is to be noted that any arbitrary combination of the above-described structural components as well as the expressions according to the present invention changed among a method, an apparatus, a system, a computer program and so forth are all effective as and encompassed by the present embodiments.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 is a block diagram showing a structure of an fingerprint authentication apparatus according to an embodiment of the present invention;

FIG. 2 illustrates fingerprint images stored in an enrolled-image storage according to an embodiment of the present invention;

FIG. 3A shows a content displayed when authentication has been successful, according to an embodiment; and FIG. 3B shows a content displayed when authentication has failed, according to an embodiment;

FIG. 4 is a flowchart showing fingerprint identification by the fingerprint authentication apparatus according to an embodiment of the present invention;

FIG. 5 is a flowchart showing the first-time verification processing according to an embodiment of the present invention; and

FIG. 6 is a flowchart showing the second-time verification processing according to an embodiment of the present invention.

### DETAILED DESCRIPTION OF THE INVENTION

The invention will now be described by reference to the preferred embodiments. This does not intend to limit the scope of the present invention, but to exemplify the invention.

An outline of the present invention will be given before a concrete description thereof. The present embodiments relate to a fingerprint authentication apparatus which authenticates the fingerprints of users in one-to-N identification. The fingerprint authentication apparatus according to the present embodiment performs an authentication processing in two separate stages. Here, a verification processing for verifying the fingerprint is carried out at each stage. The fingerprint authentication apparatus first acquires a fingerprint of a user and verifies the acquired fingerprint image against all the fingerprint images of a plurality of users enrolled in advance, as the first-time verification processing. Here, the plurality of fingerprint images registered in advance include the fingerprint image of a user himself/herself. Then a predetermined number of fingerprint images closely similar to the acquired image are selected as those to be referred to in the next verification processing. Subsequently, as the second verification processing, the acquired fingerprint image is verified against all the fingerprint images selected in the first verification processing, so as to identify the fingerprint of the user himself/herself. That is, the fingerprint authentication apparatus reduces the number of fingerprint images to be referred to in the first verification and then performs the second verification processing by referring to those fingerprint images the number of which has been reduced. As a result, the authentication processing can be achieved at high speed.

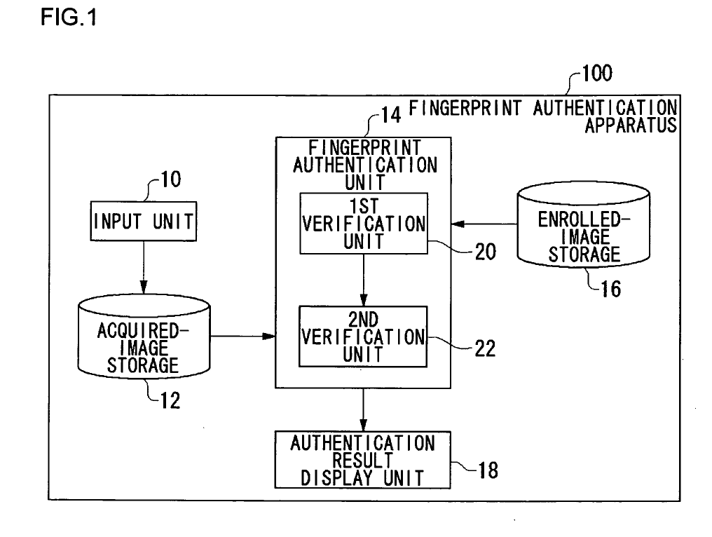

FIG. 1 is a block diagram showing a structure of an fingerprint authentication apparatus 100 according to an embodiment of the present invention. The fingerprint authentication apparatus 100 includes an input unit 10, a acquired-image storage 12, a fingerprint authentication unit 14, an enrolled-image storage 16 and an authentication result display unit 18. The input unit 10 receives the input of information on a user's fingerprint as biological information on an object to be authenticated. The input unit 10 may be a scanner or the like, for instance, and it acquires information on a user's fingerprint by producing a fingerprint image digitized by the scanner or the like.

The acquired-image storage 12 stores fingerprint images generated in the input unit 10. Hereinafter, the fingerprint images stored in the acquired-image storage 12 will be referred to as “acquired image” also.

The enrolled-image storage 16 stores beforehand fingerprint images, of a plurality of users, which are to be referred to in a verification processing described later. These fingerprints are enrolled in the enrolled-image storage 16 when a user inputs the fingerprint information in the input unit 10. Hereinafter, the fingerprint images stored in the enrolled-image storage 16 will be referred to as “enrolled images” also.

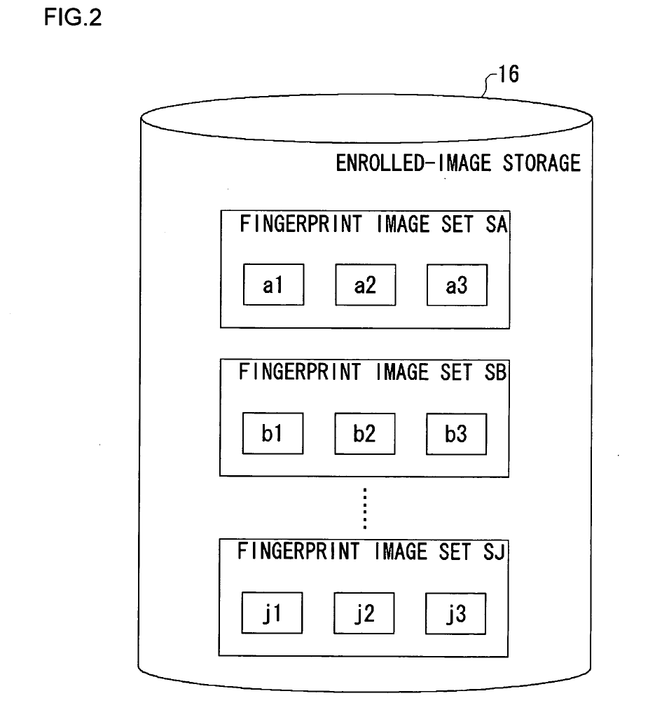

FIG. 2 illustrates fingerprint images stored in the enrolled-image storage 16. As shown in FIG. 2, the enrolled-image storage 16 stores the sets of fingerprint images SA to SJ for ten users A to J, respectively. Each set of fingerprint images contains three patterns of fingerprint images for each user. These patterns of fingerprint images are, for example, fingerprint images acquired from a user at such three different hour zones as morning, afternoon and evening. As shown in FIG. 2, the fingerprint image set SA contains, for example, a fingerprint image a1 of a user A in the morning, a fingerprint image a2 in the afternoon and a fingerprint image a3 in the evening. The fingerprint image set SB contains, for example, a fingerprint image b1 of a user B, different from the user A, in the morning, a fingerprint image b2 in the afternoon and a fingerprint image b3 in the evening. In other words, the enrolled-image storage 16 stores three fingerprint images for each of ten users, namely, the total of thirty fingerprint images.

There are cases where the shape or the like of a fingerprint, which is a region of a human body, change depending on a circumstance. For example, the water volume inside a human body differs in the morning, afternoon and evening of a day, respectively. Due to this fact, there are cases where the shape of a fingerprint varies. When the fingerprint is scanned, the shape of a fingerprint varies depending on how a finger is placed. That is, if the condition or how the finger is placed differs between when the fingerprint image is registered and when the fingerprint image is acquired by the input unit 10 at the time of fingerprint authentication, there is a possibility that the fingerprints, belonging to the same user, which should have been verified as being identical thereto are verified otherwise.

As will be described later, according to the present embodiment, when the acquired image is closely similar to any of enrolled images in the morning, afternoon and evening to a degree greater than or equal to a predetermined degree, it will be verified that the fingerprint belongs to a user himself/herself. In other words, as described above, the fingerprint images acquired in the morning, afternoon and evening for each user are enrolled beforehand, respectively, so that the identification reject rate (false nonmatch rate) can be reduced.

Referring back to FIG. 1, the fingerprint authentication unit 14 verifies twice a fingerprint image stored in the acquired-image storage 12 against the fingerprint images stored in the enrolled-image storage 16 so as to identify a user's fingerprint.

A description will now be given of a fingerprint authentication processing in the fingerprint authentication unit 14. In the present embodiment, an example in which the fingerprint of user A undergoes a fingerprint authentication processing is described. As shown in FIG. 1, the fingerprint authentication unit 14 includes a first verification unit 20 and a second verification unit 22. The first verification unit 20 performs the first-time verification processing. The second verification unit 22 performs the second-time verification processing so as to identify the user's fingerprint.

The first verification unit 20 superposes the acquired image with an enrolled image and performs the first-time verification processing by using a pattern matching method where a degree of similarity is calculated while shifting the position of the acquired image. The second verification unit 22 performs the second-time verification processing by using a minutiae method by which the degree of similarity is calculated based on the endings or bifurcations in the ridges of a fingerprint, namely attributes such as feature points or minutiae, and the relative positional relationships among those. Here, since the pattern matching method calculates the degree of similarity by superposing two fingerprints, there is no need of a processing for extracting minutiae. Hence, the period of time required for the pattern matching method is shorter compared with the minutiae method that requires a processing in which all minutiae must be extracted. In this manner, the verification processing performed in a period of time shorter than that required for the second verification processing is employed as the first-time verification processing, so that the user authentication can be done much faster.

As described above, according to the present embodiment, different methods are employed in the first-time and the second-time verification. Thereby, the fingerprint authentication unit 14 performs authentication after whether the acquired image and the enrolled images are closely similar to each other or not is determined from two different perspectives, so that the identification result will be further accurate.

Firstly, the first verification unit 20 performs the first-time verification processing of verifying fingerprint images stored in the acquired-image storage 12 against all fingerprint images stored in the enrolled-image storage 16, by use of a pattern matching method. In other words, the first verification unit 20 verifies an acquired image against the total of thirty fingerprint images for ten users. As a result of this verification, the first verification unit 20 selects the five fingerprint images in the descending order of the degree of similarity. For instance, as a result of the first-time verification, it is assumed that the selected enrolled-images are the image a3, the image d2, the image a1, the image h1 and the image j2 in the descending order of the degree of similarity.

The second verification unit 22 performs the second-time verification processing on a fingerprint image stored in the acquired-image storage 12 and the five fingerprint images of the image a3, the image d2, the image a1, the image h1 and the image j2 selected by the first verification image 20, using the minutiae method. Here, the second verification unit 22 calculates the degree of similarity between each image and the acquired image, and compares the calculated degree of similarity with a preset threshold value. As a result of the comparison, the second verification unit 22 authenticates that the user who has the fingerprint of an image having the highest degree of similarly among the enrolled images exceeding the threshold value is identical to the user who has entered the fingerprint image in the input unit. Suppose, for example, that as a result of the comparison the enrolled images exceeding the threshold value are the image a3, the image a1 and the image h1 in the descending order of the degree of similarity. The image a3 as having the highest degree of similarity is the fingerprint of the user A acquired in the evening. Then the second verification unit 22 identifies that the fingerprint held by the acquired-image storage 12 is the fingerprint of the user A.

If there is no enrolled image exceeding the threshold value, the second verification unit 22 will determine that there is no user's fingerprint image, where the fingerprint information has been inputted, in the enrolled-image storage 16. And authentication will not be performed.

In this manner, according to the present embodiment, a predetermined number of enrolled images are selected in the first-time verification processing and the thus selected enrolled images are those to be verified in the second-time verification processing. That is, since in the second-time verification there is no need to verify with all of the enrolled images, the required period of time for the second second-time verification processing is shortened by the number of enrolled images excluded from the verification. As a result, the authentication processing can be done at high speed. As described above, if the second-time verification processing is performed in a manner such that it takes longer period of time than the first-time verification processing, a longer period of time can be saved and shortened. Hence, much faster authentication processing can be realized.

Suppose, for example, that the period of time required for verifying an acquired image and a single enrolled image is such that the required time in the first-time verification processing is x seconds and the time required in the second verification processing is y seconds. Now, as described above, the enrolled-image storage 16 stores thirty fingerprint images. Then, when all of the enrolled images undergo the verification processing both in the first and the second verification processing, 30(x+y) seconds will be needed as the total verification processing. On the other hand, as described above, when five enrolled images are selected in the first-time verification processing, (30x+5y) seconds will be needed as the total verification processing. That is, according to the fingerprint authentication apparatus 100 of the present embodiment, the period of time required for the verification processing can be shortened by 25y seconds. If the second verification processing is a verification processing that requires a longer period time than the first-time verification processing, the value of y will be larger and therefore the verification processing can be performed at even higher speed.

According to the present embodiment, in the first-time verification processing the five fingerprint images are selected from the thirty enrolled images in the descending order of the degree of similarity. Accordingly, since a predetermined number of enrolled images are selected in the verification processing, the processing time can be inevitably and always shortened in the next stage. For instance, in a case where the fingerprint images determined to be closely similar in the first-time verification processing are all selected, the number of fingerprint images to be selected will be determined as a result of the determination. That is, if the number of fingerprint images is large, there may be cases where the processing time for verification can be barely saved or shortened. According to the present embodiment, on the other hand, the predetermined number of fingerprint is selected without fail, so that such an adverse effect can be avoided.

When the user's fingerprint is identified as a result of authentication by the fingerprint authentication unit 14, the authentication result display unit 18 display to the user by indicating that the authentication has been successful. On the other hand, when the user's fingerprint is not identified, the authentication result display unit 18 displays to the user by indicating that the authentication has failed. That is, in the aforementioned example, the acquired image was identified, as the image belonging to the user A, in the fingerprint authentication unit 14 and therefore the authentication result display unit 18 displays to the effect that the authentication has been successful.

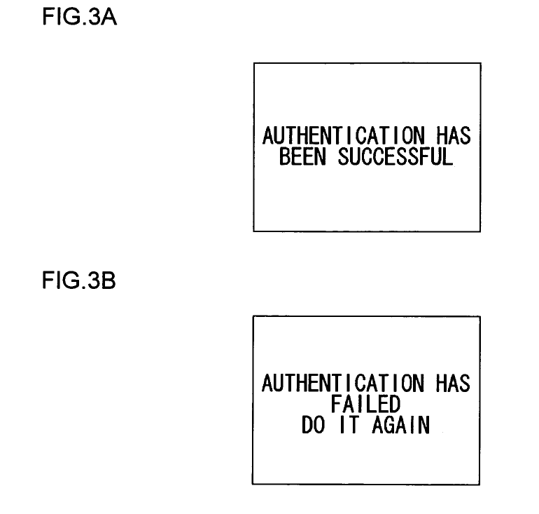

FIGS. 3A and 3B show contents displayed on the authentication result display unit 18. FIG. 3A shows a content displayed when authentication has been successful, and FIG. 3B shows a content displayed when authentication has failed. It is to be noted here that the authentication result display unit 18 may not only give such messages on a display or the like but also convey them to a PC (personal computer) or the like via a network (not shown).

An operation of the fingerprint authentication apparatus 100 that employs the above structure will now be explained.

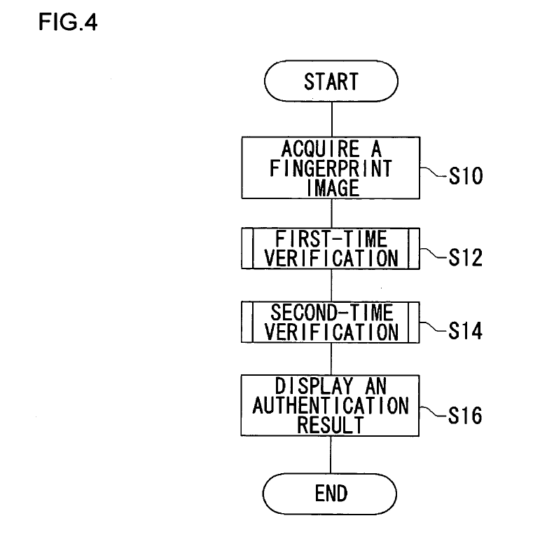

FIG. 4 is a flowchart showing fingerprint identification by the fingerprint authentication apparatus 100. Firstly, the input unit 10 acquires an image of a user's fingerprint (S10). The acquired-image storage 12 stores the fingerprint image acquired by the input unit 10. Then, the first verification unit 20 performs the first verification processing (S12). Subsequently, the second verification unit 22 performs the second verification processing and authenticates the fingerprint based on this result (S14). The authentication display unit 18 displays the authentication result to the user (S16).

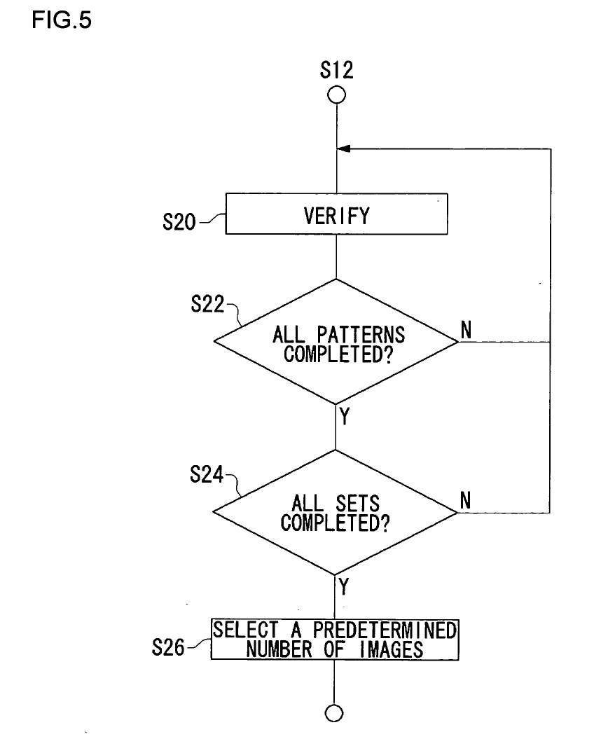

FIG. 5 is a flowchart showing the first-time verification processing according to an embodiment of the present invention. The first verification unit 20 verifies the acquired image against the images enrolled in the enrolled-image storage 16, and calculates the degrees of similarity thereof. Then the first verification unit 20 sequentially verifies the acquired image against each set of fingerprint images stored in the enrolled image storage. For each set of fingerprint images, the verification is performed on a plurality of patterns contained in the each set of fingerprint images. When the verification is completed for all of the patterns contained in a set of fingerprint images (Y of S22) and the verification is also completed for all of the sets of fingerprint images (S24), namely when the verification and the calculation of the degrees of similarity have been completed for all of the enrolled images, the first verification unit 20 selects a predetermined number of enrolled images in the descending order of the degree of similarity (S26). If, on the other hand, the verification has not been completed for all of the patterns contained in a set of fingerprint images (N of S22), the first verification unit 20 will verify the other patterns of the fingerprint set (S20). If the verification has been completed for all of the patterns (Y of S22) but not completed for all of the sets of fingerprint images (N of S24), the first verification unit 20 verifies the sets of fingerprint images which have not yet been verified (S20).

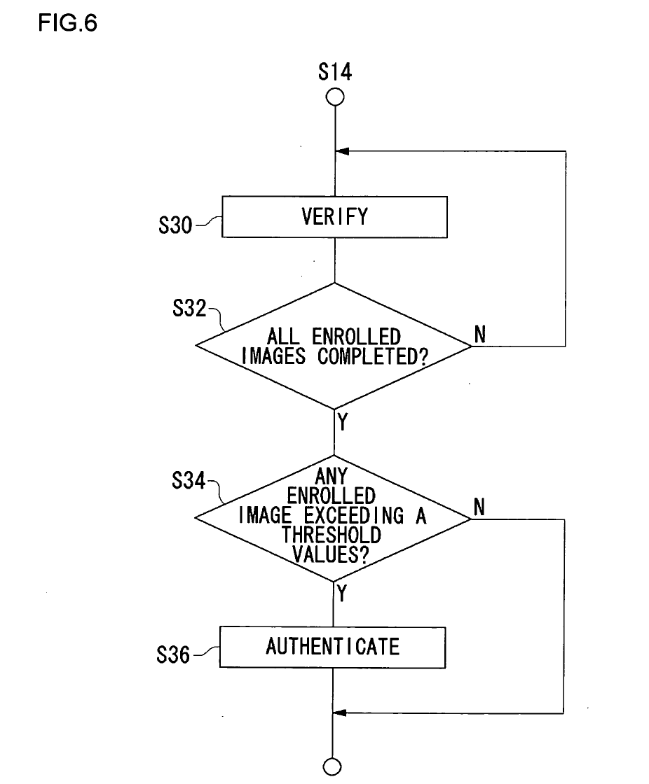

FIG. 6 is a flowchart showing the second-time verification processing according to an embodiment of the present invention. The second verification unit 22 verifies the acquired image against the enrolled images selected in the first-time verification processing, and calculates degrees of similarity between them (S30). If the verification has been completed for all the enrolled images (Y of S32) and there are enrolled images whose degrees of similarity exceed a threshold value (Y of S34), the second verification unit 22 will identify that the user having the highest degree of similarity is the user whose fingerprint image has been acquired by the input unit (S36). If the verification has not been completed for all the enrolled images (N of S32), the verification is performed on other enrolled images (S30). If in Step S34 there is no enrolled images whose degrees of similarity exceed the threshold value (N of S34), the fingerprint of the user will not be identified.

The present invention has been described based on some embodiments. Those embodiments are merely exemplary and therefore it is understood by those skilled in the art that various modifications to the combination of each component and process thereof are possible and such modifications are also within the scope of the present invention. For instance, the following modifications are conceivable.

According to the present embodiment, the enrolled-image storage 16 stores the fingerprint images acquired in the morning, the afternoon and the evening, respectively. However, the fingerprint images under different circumstances, other than the aforementioned conditions, may be stored. According to this modification, too, the identification reject rate (false nonmatch rate) can be reduced.

In the present embodiment, the enrolled-image storage 16 stores three images for each use, namely a plurality of images. However, it is not necessarily required that a plurality of images be stored for each user and, for example, a single image may be stored for each user. According to this modification, the number of enrolled images to be verified against an acquired image can be minimized, so that the authentication can be performed at high speed.

According to the present embodiment, fingerprint images are stored beforehand in the enrolled-image storage 16 and they are used for verification. As a modification, an enrolled-data storage is provided and characteristic quantities or characteristic data are stored beforehand, so that they may be used for verification. The “characteristic quantities” and “characteristic data” are, for example, the feature points or minutiae of fingerprint images in the minutiae method. The verification can be done using the characteristic quantities or characteristic data of fingerprint. According to this modification, too, the user authentication can be achieved. In other words, it is only necessary that the fingerprint authentication apparatus 100 stores the fingerprint information in advance. In this modification, the characteristic quantities or characteristic data are extracted and stored in advance. Hence, there is no need to extract the characteristic quantities or characteristic data at the time of verification, so that the period of time required for verification can be saved and shortened.

In the present embodiment, the description was given of an example where the period of time required for the first-time verification processing is shorter than that required for the second verification processing. Instead of this example, a verification processing as the first-time verification processing may be performed where the accuracy is higher than the second-time verification processing. By employing this structure, the number of fingerprint images to be referred to in the first-time verification processing can be further reduced and therefore the period of time required for the second-time verification processing can be shortened. In other words, in such a case it is preferred that the fingerprint authentication unit 14 performs the verification sequentially in a manner such that the verification is divided into a plurality of stages. Here, the “accuracy is high” means, for example, that the identification reject (false nonmatch) is unlikely to occur.

In the present embodiment, the description was given of an example where the period of time required for the first-time verification processing is shorter than that required for the second verification processing. Instead of this example, a verification processing as the first-time verification processing may be performed where the identification reject (false nonmatch) is unlikely to occur in comparison with the second-time verification processing. For example, information having less noise than in the second-time verification processing is used in the first verification processing. Or, the threshold value used in the first-time verification is set to a value lower than that used in the second-time verification processing. Here, the “noise” means information which is relatively unimportant in the verification processing.

As an example where the information having less noise than in the second-time verification processing is used in the first-time verification processing, a description will be given here of a case where a verification using the minutiae method using a small number of minutiae is performed as the first-time verification processing and a verification processing using the pattern matching method is performed as the second-time verification processing. In the pattern matching method, the entire fingerprint image is used in the verification processing. That is, in the pattern matching method, parts, other than feature points or minutiae, which are relatively unimportant in a fingerprint image, namely the noise also undergoes the verification processing. On the other hand, in the minutiae method, the feature points of a fingerprint are used. That is, in the minutiae method, the verification processing is performed on the important feature points of a fingerprint and the noise does not undergo the verification processing. Thus, in general the identification reject (false nonmatch) is less likely to occur in the minutiae method as compared to the pattern matching method.

Here, an enrolled-data storage is provided where the characteristic quantities, characteristic data and fingerprint image data extracted from users are stored beforehand. And the characteristic quantities, characteristic data and fingerprint data stored therein are used in the first-time and the second-time verification processing.

According to this example, an enrolled image or images belonging to a right user are selected at a further high probability in the first-time verification processing, and then the second-time verification processing is performed using those selected enrolled-images. Hence, the result of verification is further accurate.

Also, if the number of feature points is reduced in the verification employing the minutiae method, the probability of the occurrence of identification rejection (false nonmatch) can be further reduced. Also, the verification processing can be done at higher speed by as much as a decrease in the feature points.

In the present embodiment, the enrolled images which have been selected in the first-time verification processing are used in the second-time verification processing. As a modification, an intermediate result such as angles of rotation among the fingerprint images and the quality of reference data as well as a verification result such as degrees of similarity are acquired in the first verification processing and are added to the selected enrolled-images and then the thus acquired information may be used in the second-time verification processing. Here, “the quality of reference data” is, for instance, a degree of contrasting density of a fingerprint image or a degree of humidity thereof.

For example, when in the first-time verification processing the angles of rotations of fingerprint images are acquired and they are used in the second-time verification processing, information on the angles of rotation acquired in the first-time verification processing is used in the pattern matching method where it is oftentimes troublesome to verify fingerprint images with rotational differences. As a result, the result in the second-time verification is further accurate.

When, for example, the degree of contrasting density of a fingerprint image is obtained as the quality of reference data in the first-time verification processing and is then used for the second-time verification processing, the second-time verification processing is performed after the degree of contrasting density of a fingerprint images is raised, based on the information indicating, for example, that the degree of contrasting density thereof is low. As a result, the second-time verification processing can be performed in a satisfactory manner.

According to the present embodiment, the verification processing is performed twice in an authentication processing but it may be performed more than twice. According to this modification, the result of authentication becomes further accurate by as much as the additional number of verification processings.

According to the present embodiment, different methods are used in the first and the second verification processing, respectively, but as a modification the same method may be used for verification. According to this modification, the result of authentication becomes further accurate by as much as the repeated verification processing.

For example, a description is given here of an example where as the first and the second verification processing a fingerprint image is partitioned and a verification is carried out based on feature points or minutiae extracted from the partitioned images, respectively. In this example, in the first-time verification processing a fingerprint image is partitioned in the vertical direction and in the second verification processing the fingerprint image is partitioned, in the horizontal direction, into a plurality of regions the number of which is greater than that in the first-time verification processing. That is, the second-time verification processing takes a longer period of time than the first-time verification processing by as much as the increase in the number of partitioned regions. In the light of this, the high-speed authentication processing can be attempted by further reducing the second-time verification processing time and the accuracy in the authentication result can be raised.

In the present embodiments, the description has been given of fingerprint authentication. As still another modification, the present invention is also applicable to any type of authentication using such biological information as palm print, face image, iris image, retina image, venous information or voiceprint.

While the preferred embodiments of the present invention have been described using specific terms, such description is for illustrative purposes only, and it is to be understood that changes and variations may be further made without departing from the spirit or scope of the appended claims.

What is claimed is:

1. An authentication apparatus, comprising:
an input unit which inputs biological information on an object to be authenticated;
a storage which stores a plurality of pieces of reference information to be referred to the biological information inputted in said input unit; and
an authentication unit which authenticates the biological information in a manner such that verification of the biological information against the plurality of pieces of reference information stored in said storage is performed sequentially in two stages,
wherein, in the two stages in the verification in said authentication unit, reference information to be used in the subsequent stage is selected, in the earlier stage thereof, by verifying the biological information against the plurality of pieces of reference information, and wherein the biological information is verified against the selected reference information in the subsequent stage so as to identify the biological information.

2. An authentication apparatus according to claim 1, wherein said authentication unit uses different processings for verification in the two stages, respectively, and uses, in the earlier stage, a processing whose period of time required for verification is shorter than that required for the subsequent stage.

3. An authentication apparatus according to claim 1, wherein said authentication unit uses different processings for verification in the two stages, respectively, and uses, in the earlier stage, a processing such that the identification rejection is less likely to occur than in the subsequent stage.

4. An authentication apparatus according to claim 1, wherein each of the plurality of pieces of reference information stored in said storage contains a plurality of patterns, and
wherein said authentication unit verifies the biological information against each of the plurality of patterns in each of the two stages, and wherein when the biological information corresponds to at least one of the plurality of patterns, the biological information is identified.

5. An authentication apparatus according to claim 2, wherein each of the plurality of pieces of reference information stored in said storage contains a plurality of patterns, and
wherein said authentication unit verifies the biological information against each of the plurality of patterns in each of the two stages, and wherein when the biological information corresponds to at least one of the plurality of patterns, the biological information is identified.

6. An authentication apparatus according to claim 3, wherein each of the plurality of pieces of reference information stored in said storage contains a plurality of patterns, and
wherein said authentication unit verifies the biological information against each of the plurality of patterns in each of the two stages, and wherein when the biological information corresponds to at least one of the plurality of patterns, the biological information is identified.

7. An authentication apparatus, comprising:
an input unit which inputs biological information on an object to be authenticated;
a storage which stores a plurality of pieces of reference information to be referred to the biological information inputted in said input unit; and
an authentication unit which authenticates the biological information in a manner such that verification of the biological information against the plurality of pieces of reference information stored in said storage is performed sequentially in a plurality of stages,
wherein, in one of the plurality of stages in the verification in said authentication unit, reference information to be used in a subsequent stage is selected from reference information selected in an earlier stage of verification by verifying the biological information against the reference information selected in the earlier stage of verification.

8. An authentication apparatus according to claim 7, wherein said authentication unit uses different processings for verification in the plurality of stages, respectively, and uses, in one of the plurality of stages, a processing whose period of time required for verification is shorter than that required for a subsequent stage.

9. An authentication apparatus according to claim 7, wherein said authentication unit uses different processings for verification in the plurality of stages, respectively, and uses, in one of the plurality of stages, a processing such that the identification rejection is less likely to occur than in a subsequent stage.

10. An authentication apparatus according to claim 7, wherein each of the plurality of pieces of reference information stored in said storage contains a plurality of patterns, and
wherein said authentication unit verifies the biological information against each of the plurality of patterns in each of the plurality of stages, and wherein when the biological information corresponds to at least one of the plurality of patterns, the biological information is identified.

11. An authentication apparatus according to claim 8, wherein each of the plurality of pieces of reference information stored in said storage contains a plurality of patterns, and
wherein said authentication unit verifies the biological information against each of the plurality of patterns in each of the plurality of stages, and wherein when the biological information corresponds to at least one of the plurality of patterns, the biological information is identified.

12. An authentication apparatus according to claim 9, wherein each of the plurality of pieces of reference information stored in said storage contains a plurality of patterns, and
wherein said authentication unit verifies the biological information against each of the plurality of patterns in each of the plurality of stages, and wherein when the biological information corresponds to at least one of the plurality of patterns, the biological information is identified.
